(19) United States
(12) Patent Application Publication
(10) Pub. No.: US 2024/0323303 A1
(43) Pub. Date: Sep. 26, 2024

(54) INFORMATION PROCESSING APPARATUS, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: RYUJI NAGAHARA, Kanagawa (JP)

(21) Appl. No.: 18/602,125

(22) Filed: Mar. 12, 2024

(30) Foreign Application Priority Data
Mar. 22, 2023 (JP) 2023-045789

(51) Int. Cl. H04N 1/327; H04N 1/00

(52) U.S. Cl. CPC H04N 1/32793; H04N 1/00896

(57) ABSTRACT

An information processing apparatus capable of executing communication by a Neighbor Awareness Network (NAN), includes: a change unit that executes change processing of changing a state of the information processing apparatus from a state in which the first setting is validated to a state in which the second setting is validated based on a fact that the information processing apparatus is determined to be operated as a Master in a NAN cluster in which the information processing apparatus participates in a state in which the first setting is validated.

### BACKGROUND OF THE INVENTION

### Field of the Invention

The present invention relates to an information processing apparatus, a method, and a non-transitory computer-readable storage medium storing a program.

### Description of the Related Art

In recent years, a wireless Local Area Network (LAN) represented by the IEEE 802.11 standard series has been used widely. Along with this, many printing apparatuses such as multifunction peripherals and printers have a wireless LAN function. The printing apparatus having the wireless LAN function receives printing data from an external device such as a mobile terminal by wireless communication and executes printing processing based on the received printing data.

In Wi-Fi Aware certified by Wi-Fi Alliance, Neighbor Awareness Networking (NAN) capable of detecting a service provided by a neighboring communication apparatus is defined. This aims at achieving energy saving by shortening a time for validating a Radio Frequency (RF) unit in synchronism with a time for exchanging information between the communication apparatus and another communication apparatus.

A synchronization period in NAN is called a Discovery Window (DW), and the DW period is repeated at a predetermined cycle. A set of NAN devices sharing the same DW period is called a NAN cluster. Each communication apparatus belonging to the NAN cluster operates as one of roles of Master, Non-Master Sync, and Non-Master Non-Sync. Japanese Patent Laid-Open No. 2018-14574 describes a method of detecting a NAN cluster to which the communication apparatus belongs and determines a role in the NAN cluster.

### SUMMARY OF THE INVENTION

A widely-used apparatus using a predetermined communication method such as Wi-Fi Aware is required to be controlled to appropriately execute role determination by the predetermined communication method.

The present invention provides a technique for appropriately executing role determination by the predetermined communication method.

The present invention in one aspect provides an information processing apparatus capable of executing communication by a Neighbor Awareness Network (NAN), comprising at least one memory and at least one processor which function as: a setting unit configured to set, in the information processing apparatus, any setting among a plurality of setting including a first setting and a second setting, wherein the first setting is a setting for operating the information processing apparatus in a predetermined power saving mode based on a fact that a predetermined condition for operating the information processing apparatus in the predetermined power saving mode is satisfied, and the second setting is a setting for inhibiting the information processing apparatus from operating in the predetermined power saving mode even if the predetermined condition is satisfied; a control unit configured to operate the information processing apparatus in the predetermined power saving mode based on a fact that the predetermined condition is satisfied in a state in which the first setting is validated; and a change unit configured to execute change processing of changing a state of the information processing apparatus from a state in which the first setting is validated to a state in which the second setting is validated based on a fact that the information processing apparatus is determined to be operated as a Master in a NAN cluster in which the information processing apparatus participates in a state in which the first setting is validated.

The present invention can control so that the role determination by the predetermined communication method can be appropriately executed.

Further features of the present invention will become apparent from the following description of exemplary embodiments with reference to the attached drawings.

### BRIEF DESCRIPTION OF THE DRAWINGS

FIG. 1 is a block diagram showing the arrangement of a network;

FIG. 2 is a block diagram showing the functional arrangement of a NAN device;

FIG. 3 is a block diagram showing the hardware arrangement of an information processing apparatus;

FIG. 4 is a block diagram showing the first energy saving state;

FIG. 5 is a flowchart showing processing of changing a mode from a normal power mode to an energy saving mode;

FIG. 6 is a view showing a user interface screen;

FIG. 7 is a flowchart showing processing executed in the information processing apparatus;

FIGS. 8A and 8B are flowcharts showing processing executed in the information processing apparatus;

FIG. 9 is a flowchart showing processing executed in the information processing apparatus; and

FIG. 10 is a flowchart showing processing executed in the information processing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

An example in which a wireless LAN system complying with the standard of a protocol called a Neighbor Awareness Network (NAN) in the Wi-Fi Aware communication standard certified in Wi-Fi Alliance will be described below. In the following description, the standard of a communication apparatus is called a “NAN standard”, and a network for the service search and discovery, which is formed in accordance with the NAN standard is called a “NAN”. A communication apparatus operated in accordance with the NAN standard is called a NAN device. A set of NAN devices using a common Discovery Window (DW) period is called a NAN cluster. Note that the communication apparatus is an apparatus capable of performing communication based on the NAN, and various apparatuses such as a camera, a projector, a scanner, a printer, a television set, a game machine, a mobile terminal, and a smart speaker can be applied as the communication apparatus.

In the NAN, the NAN cluster is defined by a set of NAN devices sharing the cycle for turning on an RF function, and the NAN device participates in the NAN cluster. In this embodiment, the NAN devices participating in the NAN cluster construct a network in 6 ch (2.437 GHz) in the 2.4 GHz frequency band. The NAN cluster has the length of the DW period of 16 Time Unit (TU which is 1,024 μs). The time interval from the start timing of the DW period to the start timing of the next DW period is a 512-TU NAN cluster. Note that the frequency channel and the DW period which are used in the NAN cluster are not limited to these, and at least one of another frequency channel and a DW period having another period length or interval may be used.

A Master Rank defined in the NAN standard is set in each NAN device as a factor for determining a role in the NAN cluster. The Master Rank is determined from s Master Preference, a random value (Random Factor), and a NAN interface Address, which are set in each NAN device. The Master Preference is a value arbitrarily determined by the NAN device in the range of 0 to 255. The NAN interface Address is an address for identifying a NAN device. More specifically, the Master Rank of the device is determined by

Master Preference×2\hat{ }56+Random Factor×2\hat{ }48+NAN interface Address

The NAN device easily plays a role of the Master if the Master Rank is higher, and easily plays a role of the Non-MASTER Non-Sync if the Master Rank is lower. The NAN device having the highest Master Rank in the NAN cluster is called an Anchor Master and plays a role as the time reference in the NAN cluster. It is recommended that in the NAN standard, the Master Rnak is increased for a NAN device stably participating in the NAN cluster, such as a NAN device which is driven by a power supply and whose location is not moved. Like battery-driven equipment or a mobile terminal, it is recommended that the Master Rank is decreased for a NAN device which cannot exist stably in the NAN cluster. In a case where the NAN device staying stably in the NAN cluster becomes a Master and transmits a sync signal, the NAN cluster is maintained stably.

The communication apparatus operated as the Master causes another communication apparatus to identify the DW and cyclically transmits a Synchronization Beacon (to be referred to as a Sync Beacon hereinafter) serving a beacon synchronized with the DW period. In addition, the communication apparatus operated as the Master transmits a Discovery Beacon serving as a signal for recognizing a given NAN cluster to a communication apparatus which does not belong to the given NAN cluster. The Discovery Beacon is transmitted in a period (for example, every 100 ms) which is not the DW period. In the NAN cluster, at least one communication apparatus operates as the Master. A NAN device operating as the Non-Master Sync transmits the Sync Beacon for performing identification and synchronization of the DW by each NAN device, but does not transmit a Discovery Beacon. A NAN device operating as the Non-Master Non-Sync transmits neither the Sync Beacon nor the Discovery Beacon.

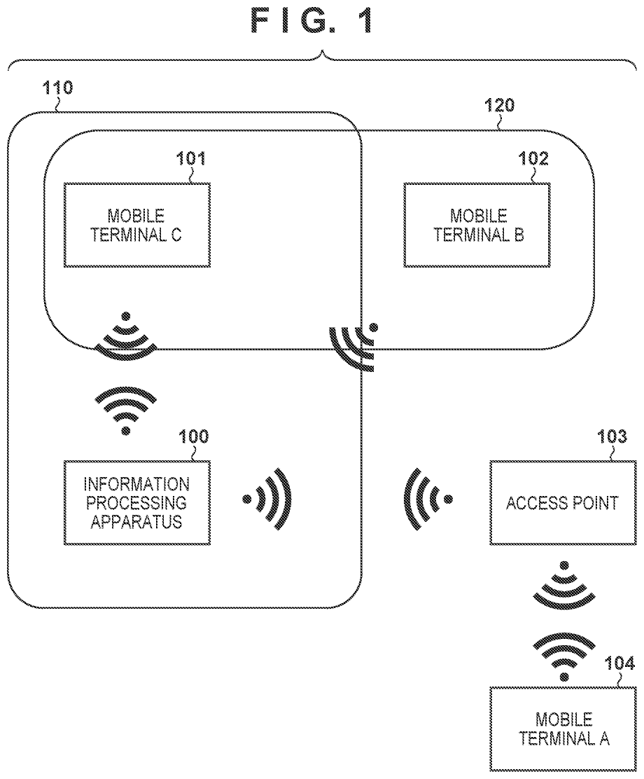

FIG. 1 is a block diagram showing an example of a network arrangement in this embodiment. Each device in FIG. 1 can be an NAN device (the communication apparatus in the above description) in the NAN. An information processing apparatus 100 includes a wireless LAN interface can perform wireless communication without being via mobile terminals 101 and 102, and an access point including a similar wireless LAN interface. In this embodiment, the information processing apparatus 100 is a printer, but can be applied as apparatus other than the printer, as described above. The wireless communication (so-called point-to-point (P2P) communication without being via the access point is communication by, for example, Wi-Fi Direct or Wi-Fi Aware. The information processing apparatus 100 can execute wireless communication with a mobile terminal 104 via an access point 103. Each communication apparatus in the network in FIG. 1 holds an IP address, a MAC address, infrastructure-side wireless communication interface information, and P2P-side wireless communication interface information.

In FIG. 1, the information processing apparatus 100 and the mobile terminal 101 form a NAN cluster 110, and the mobile terminal 101 and the mobile terminal 102 form a NAN cluster 120. As described above, the communication apparatus operating as the Master in the NAN transmits a Discovery Beacon serving as a signal for recognizing the NAN cluster to another communication apparatus which does not belong to the NAN cluster. Another communication apparatus identifies a DW by the Discovery Beacon. In the corresponding DW period, a Publish message serving as a signal for searching for a service and a Subscribe message for notifying that the service is provided are transmitted or received. As a result, the detection and provision of the service are performed. In each of the information processing apparatus 100, the mobile terminal 101, and the mobile terminal 102 which belong to the NAN cluster, a Master Rank defined by the NAN standard as a factor for determining a role in each NAN cluster is set.

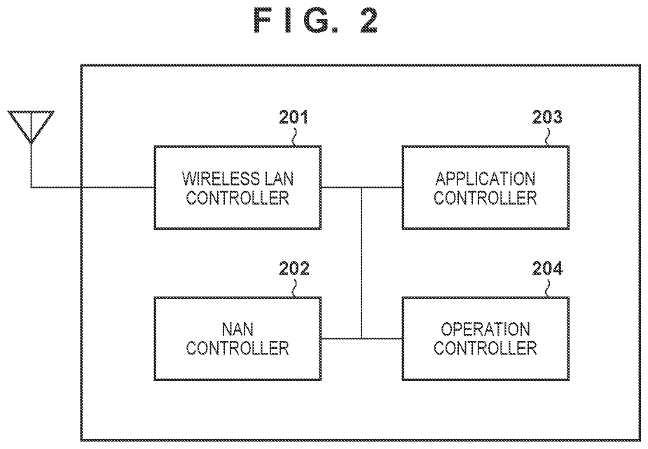

FIG. 2 is a block diagram showing an example of a NAN device functional arrangement. The arrangement shown in FIG. 2 can be applied to each communication apparatus in the network in FIG. 1. As the functional arrangement, the NAN device includes, for example, a wireless LAN controller 201, a NAN controller 202, an application controller 203, and an operation controller 204.

The wireless LAN controller 201 controls transmission/reception of a wireless signal in accordance with the corresponding wireless LAN signal format with a communication apparatus capable of performing communication by another wireless LAN. In addition, the wireless LAN controller 201 executes various communication control operations associated with the wireless LAN in accordance with the IEEE802.11 standard series. The NAN controller 202 executes various control operations such as service search/discovery in accordance with the NAN standard. In addition, the NAN controller 202 executes NAN function start processing and role determination processing. The NAN controller 202 controls the wireless communication operation of the wireless LAN controller 201 in accordance with the role determined in the role determination processing.

The application controller 203 gives, to the NAN controller 202, a trigger so as to start or end the NAN function in accordance with the application processing. In addition, the NAN controller 202 forms a network with equipment found by the NAN function. The wireless LAN controller 201 communicates the application data under the control of the application controller 203. For example, when a user (not shown) of the NAN device activates an image sharing service application using the NAN, the application controller 203 instructs the start processing of the NAN function to the NAN controller 202. After that, the NAN controller 202 controls the wireless LAN controller 201 to form the network in accordance with the found equipment in accordance with the IEEE 802.11 standard series, and transmit/receive image data via the formed network. On the other hand, if the user of the NAN device ends the application, the application controller 203 instructs the end processing of the NAN function to the NAN controller 202. Note that application data communication is performed not by the NAN standard, but by another communication standard.

The operation controller 204 accepts an operation from the user of the NAN device and manages the operation, and transmits appropriate signals to the wireless LAN controller 201, the NAN controller 202, and the application controller 203 at appropriate timings in accordance with this operation.

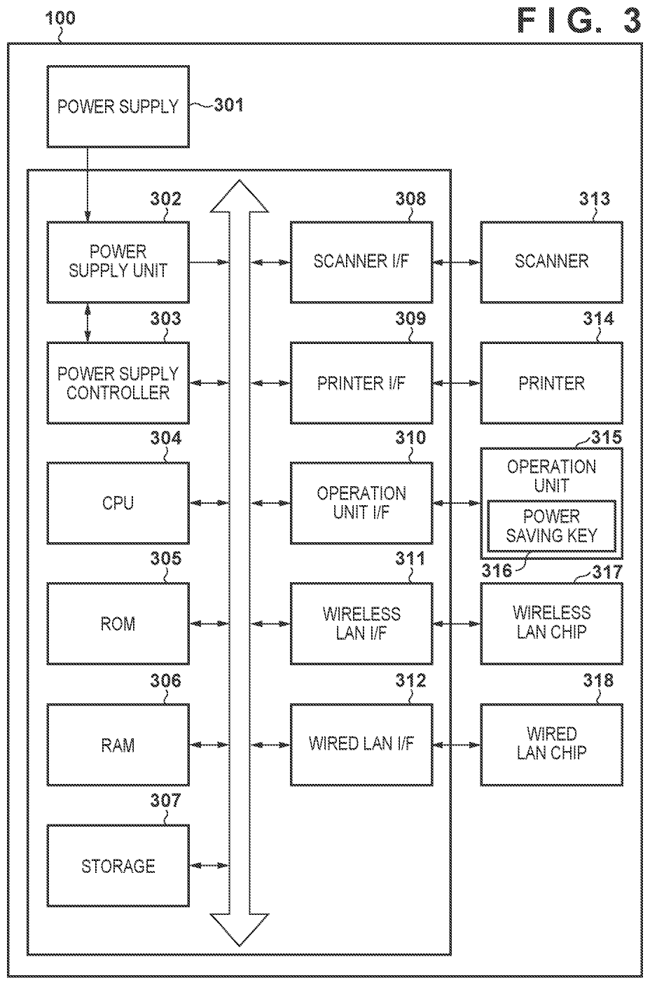

FIG. 3 is a block diagram showing an example of the hardware arrangement of the information processing apparatus 100. In this embodiment, the information processing apparatus 100 will be described as an image forming apparatus such a printer. However, the information processing apparatus 100 may be a general-purpose information processing apparatus such as a PC or a smartphone.

A CPU 304 reads out a control program stored in a ROM 305 and executes various processing operations for comprehensively controlling the operation of the information processing apparatus 100. The ROM 305 stores the control program, application, and data. Note that in the information processing apparatus 100, one CPU 304 executes each process shown in a flowchart to be described later, but another form may be employed. For example, a plurality of CPUs may cooperate with each other to execute each process shown in the flowchart to be described later.

A RAM 306 is used as a main memory of the CPU 304 and a temporary storage area such as a work area. A storage 307 is a storage device such as a Hard Disk Drive (HDD) or a Solid State Drive (SSD) and stores various data such as printing target image data and scanned image data.

An operation unit I/F 310 controls an operation unit 315 in accordance with an instruction from the CPU 304. The operation unit 315 includes a liquid crystal display unit having a touch panel function, and physical keys including a power saving key 316 and displays various user interface screens. The operation unit 315 can receive an instruction operation and information input by the user to the information processing apparatus 100.

A scanner I/F 308 controls a scanner 313 by an instruction from the CPU 304. The scanner 313 optically reads an image of an original placed on a document table (not shown) or an Auto Document Feeder (ADF)(not shown) and generates scanned image data. A printer I/F 309 controls a printer 314 in accordance with an instruction from the CPU 304. The printer 314 forms, on a print medium, an image based on the image data. Various printing methods such as an inkjet printing method, an electrophotographic method, or the like can be applied to the printer I/F 309 and the printer 314.

A wireless LAN I/F 311 implements data communication by wireless LAN with an external apparatus such as a PC via a wireless LAN chip 317. The wireless LAN I/F 311 has a wireless infrastructure as the connection type of the wireless LAN and a connection type such as wireless direct. The wired LAN I/F 312 executes data communication by wired LAN with the external apparatus such as a PC via a wired LAN chip 318.

A power supply controller 303 has a function of performing power supply control for supplying the power supplied from a power supply 301 to a power supply unit 302 to necessary portions in the information processing apparatus 100. In this embodiment, the information processing apparatus 100 can be operated as a normal power mode serving as a general power state, and a first power saving mode serving as the first power saving state whose power consumption is smaller than that in the normal power mode. In addition, the information processing apparatus 100 can be operated as a second power saving mode serving as the second power saving state whose power consumption is smaller than the first power saving mode. In this embodiment, a description will be made assuming that the information processing apparatus 100 has two power saving modes but may have three or more different power saving modes.

In this embodiment, a description will be made by an arrangement in which power is supplied to all the blocks shown in FIG. 3 in the normal power state. However, even in the normal power state, power is not supplied to all the blocks but may be supplied to only some blocks including at least the wireless LAN I/F 311 and the wireless LAN chip 317.

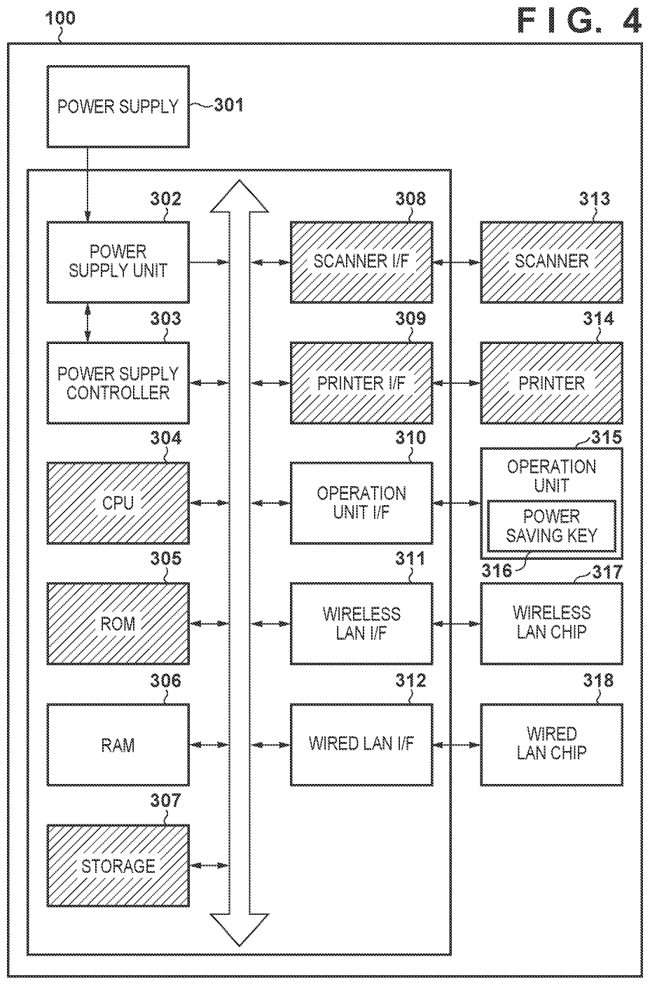

FIG. 4 is a block diagram showing the power feed state (first power saving state) in the first power saving mode of the information processing apparatus 100. That is, portions displayed in gray in FIG. 4 are blocks to which the power is not supplied. The blocks to which the power is supplied from the power supply unit 302 in the first power saving mode are the RAM 306, the power saving key 316, the operation unit I/F 310, the wireless LAN I/F 311, the wireless LAN chip 317, the wired LAN I/F 312, and the wired LAN chip 318. However, if the power is supplied to the wireless LAN I/F 311 and the wireless LAN chip 317, and the power consumption is smaller than that in the normal power mode, the blocks serving as the power supply targets in the first power saving mode are not limited to those in FIG. 4. For example, power may be supplied to the RAM 306 as needed. In addition, although the description has been made assuming that the power supply to the operation unit 315 is limited to only the power saving key 316, the power may be supplied to the operation unit 315 in accordance with recognition of the user's touch.

If the information processing apparatus 100 is changed to the second power saving mode, the power supply to the wireless LAN I/F 311 and the wireless LAN chip 317 is stopped from the power supply state in the first power saving mode shown in FIG. 4. If the second power saving mode is set, wireless communication between the mobile terminals 101 and 102 and the access point 103 and wireless LAN communication operation including transmission of a beacon such as the Discovery Beacon are disabled.

Here, a change in mode between the normal power mode, the first power saving mode, and the second power saving mode in the information processing apparatus 100 will be described below. First, processing of changing the mode from the normal power mode to the power saving mode will be described.

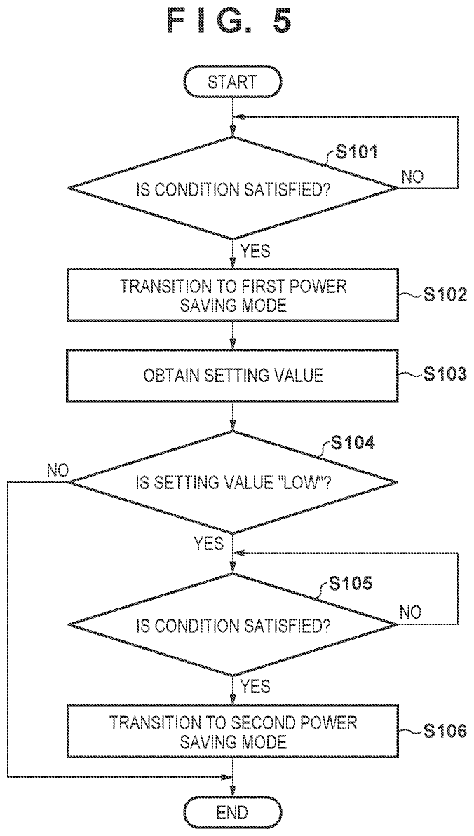

FIG. 5 is a flowchart showing processing of changing the mode from the normal power mode to the power saving mode. Processing in FIG. 5 is executed by, for example, the power supply controller 303.

In step S101, the power supply controller 303 monitors whether a condition (to be referred to as the first condition hereinafter) for changing the mode to the first power saving mode is satisfied. That is, processing in step S101 is repeated until it is determined that the first condition is satisfied. Here, the first condition is given such that the power saving key 316 is pressed by the user, no user operation is performed for a predetermined period, or the printing job is not received from the wireless LAN chip 317 or the wired LAN chip 318 for a predetermined period. If it is determined that the first condition is satisfied, the power supply to each block is controlled by the power supply controller 303 so that, for example, the mode is set from the normal power state in FIG. 3 to the first power saving state in FIG. 4, and the mode of the information processing apparatus 100 is changed to the first power saving mode in step S102.

In step S103, the power supply controller 303 obtains a setting value concerning the power saving mode.

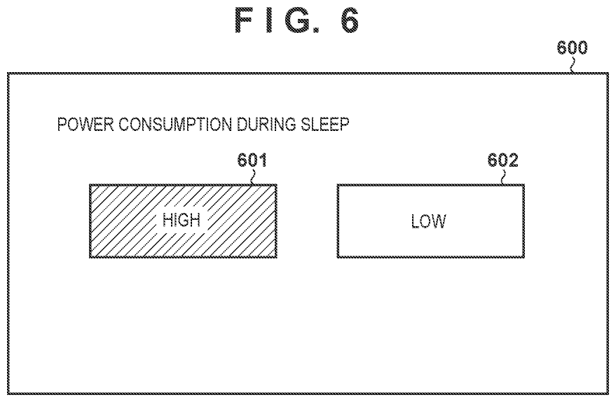

FIG. 6 is a view showing an example of a setting screen concerning the power saving mode displayed on the operation unit 315 of the information processing apparatus 100. A setting screen 600 is displayed by, for example, selecting the item of a power saving setting from the main menu screen of the information processing apparatus 100. As shown in FIG. 6, a “high” button 601 and a “low” button 602 as the power consumption in the sleep state (the power saving state) are displayed on the setting screen 600. The user can select any one of the buttons. The user presses the “low” button 602 to change the state to a state in which power consumption is set low in the information processing apparatus 100. The state in which the power consumption is lower is the second power saving mode. That is, the “high” button 601 is a button for the setting (first setting) for inhibiting the change to the second power saving mode even if the condition for changing the mode to the second power saving mode is satisfied. The “low” button 602 is a button for the setting (second setting) for allowing the change to the second power saving mode if the condition for changing the mode to the second power saving mode is satisfied. In step S103, a setting value, for example, “high” or “low” setting value of the setting screen 600 is obtained.

Note that as described above, the Master Rank and the Master Preference are values representing easiness of setting the Master of the NAN device. In addition, as described, the NAN device can arbitrarily change or determine the Master Preference. However, in this embodiment, assume that the Master Preference in a state in which the first setting is performed by operating the “high” button 601 and the Master Preference in a state in which the second setting is performed by operating the “low” button 602 are identical. In other words, even if the setting of the information processing apparatus 100 is changed between the first setting and the second setting, the Master Preference of the information processing apparatus 100 is not changed.

The power supply controller 303 determines in step S104 whether the setting value is “low”. If NO in step S104, that is, if “high” is set, for example, on the setting screen 600, processing in FIG. 5 ends. Otherwise, the process advances to step S105.

In step S105, the power supply controller 303 monitors whether a condition (to be referred to as the second condition hereinafter) for changing the mode to the second power saving mode is satisfied. That is, processing in step S105 is repeated until it is determined that the second condition is satisfied. The second condition is given such that processing in the first power saving mode does not receive the necessary communication data for a predetermined period. If it is determined that the second condition is satisfied, in step S106, by stopping the power supply to the wireless LAN I/F 311 and the wireless LAN chip 317, the power supply controller 303 changes the mode of the information processing apparatus 100 from the first power saving state in FIG. 4 to the second power saving mode. When changing the mode to the second power saving mode, the wireless communication between the mobile terminals 101 and 102 and the access point 103 and the wireless LAN communication operation including transmission of a beacon such as the Discovery Beacon are stopped. After step S106, processing in FIG. 5 ends.

If “low” is set on the setting screen 600 by the user in the information processing apparatus 100, the power consumption can be reduced to the second power saving mode via the first power saving mode. On the other hand, if “high” is set on the setting screen 600 by the user, the decrease in power consumption is limited until the first power saving mode, and the mode will not be changed to the second power saving mode.

The return from the power saving mode will be described next.

If a condition (to be referred to as the third condition hereinafter) is satisfied in a case where the information processing apparatus 100 is set in the first power saving mode, the power supply controller 303 starts the power supply to a block which has not been supplied with power, and returns the information processing apparatus 100 to the normal power mode. The third condition is given such that, for example, the wireless LAN I/F 311 or the wired LAN I/F 312 receives a job required to change the mode to the normal power mode, such as the printing job, via the wireless LAN chip 317 or the wired LAN chip 318. For example, the third condition is given such that, for example, the user presses the power saving key 316.

If a condition (to be referred to as the fourth condition hereinafter) is satisfied in a case where the information processing apparatus 100 is set in the second power saving mode, the power supply controller 303 starts the power supply to the wireless LAN I/F 311 and the wireless LAN chip 317 in which the power has not been supplied, and returns the information processing apparatus 100 to the first power saving mode. Here, the fourth condition is given such that, for example, the user presses the power saving key 316. If the information processing apparatus 100 returns to the first power saving mode, the wireless communication between the mobile terminals 101 and 102 and the access point 103 and the wireless LAN communication operation including transmission of a beacon such as the Discovery Beacon are enabled.

If the fourth condition is satisfied in the second power saving mode in the information processing apparatus 100 according to this embodiment, the information processing apparatus 100 returns to the first power saving mode. After that, if the third condition is satisfied in the first power saving mode, the information processing apparatus 100 returns to the normal power mode. However, if the fourth condition is satisfied in the second power saving mode, the information processing apparatus 100 may return to the normal power mode.

Processing executed when activating Wi-Fi Aware in the information processing apparatus 100 will be described below.

As described above, if it is determined that the information processing apparatus 100 operates as the Master in the NAN cluster, the information processing apparatus 100 must transmit the Discovery Beacon. However, if the information processing apparatus 100 is changed to the second power saving mode, since the power supply to the wireless LAN chip is stopped, the Discovery Beacon cannot be transmitted. To cope with this, according to this embodiment, setting concerning a change to the power saving mode is controlled, as needed, in accordance with the role determined in the NAN cluster of the information processing apparatus 100.

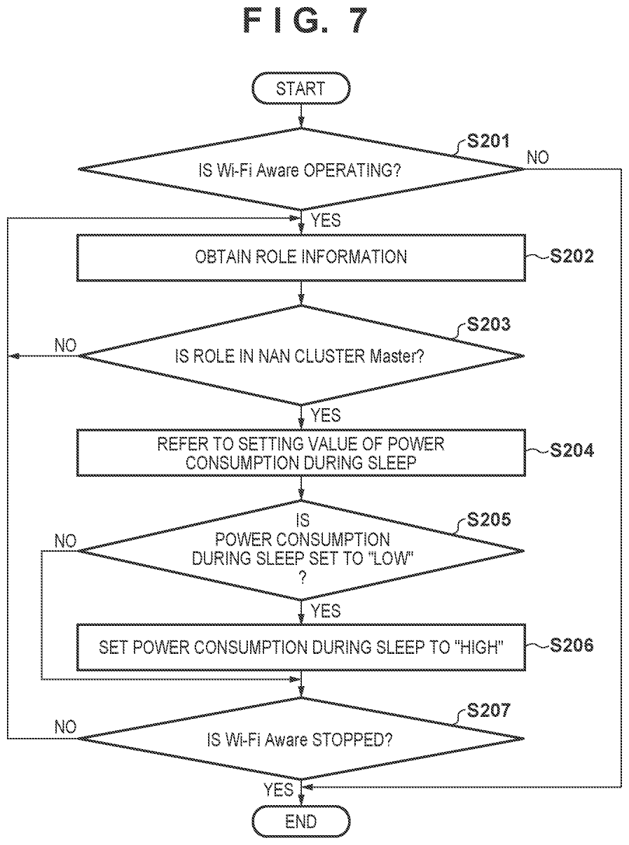

FIG. 7 is a flowchart showing processing executed when activating Wi-Fi Aware in the information processing apparatus 100. The processing in FIG. 7 is implemented by, for example, the CPU 304 deploying the control program stored in a memory such as a ROM 305 into a RAM 306 and executing it.

After the information processing apparatus 100 is powered on, the CPU 304 determines in step S201 whether Wi-Fi Aware is operating. The processing in step S201 is executed by causing the application controller 203 in FIG. 2 to obtain information from the wireless LAN controller 201 or the NAN controller 202. If it is determined that Wi-Fi Aware is not operating, the processing in FIG. 7 ends. If it is determined that Wi-Fi Aware is operating, the process advances to step S202.

In step S202, the CPU 304 obtains information concerning the role of the information processing apparatus 100 in the NAN cluster. The processing in step S202 is executed by, for example, causing the application controller 203 in FIG. 2 to obtain information from the wireless LAN controller 201 or the NAN controller 202. In step S203, the CPU 204 determines based on the obtained information whether the role in the NAN cluster of the information processing apparatus 100 is the Master. The processing in step S203 is executed by, for example, the application controller 203.

If it is determined that the role in the NAN cluster is not the Master, processing from step S202 is repeated. On the other hand, if it is determined that the role in the NAN cluster is the Master, the process advances to step S204.

In step S204, the CPU 304 obtains the setting value concerning the power saving mode. Here, for example, the setting value, for example “high” or “low” setting value of the setting screen 600 is obtained. Processing in step S204 is executed by the application controller 203.

The CPU 304 determines in step S205 whether the setting value is “low”. If NO in step S205, for example, if “high” is set on the setting screen 600, the process advances to step S207. If it is determined that the setting value is “low”, the process advances to step S206. The processing in step S205 is executed by, for example, the application controller 203.

In step S206, the CPU 304 sets the setting value to “high”. That is, the setting value is changed from “low” to “high”. The processing in step S206 is executed by, for example, the application controller 203. After step S206, the process advances to step S207.

By changing the setting value to “high” in step S206, the processing operations in steps S105 and S106 in FIG. 5 are controlled not to be executed. That is, the information processing apparatus 100 is not changed to the second power saving mode, and power supply to the wireless LAN I/F 311 and the wireless LAN chip 317 is maintained. Accordingly, transmission of the Discovery Beacon is stably performed.

The CPU 304 determines in step S207 whether Wi-Fi Aware is stopped. The processing in step S207 is executed by, for example, causing the application controller 203 to obtain information from the wireless LAN controller 201 or the NAN controller 202. If it is determined Wi-Fi Aware is stopped, processing in FIG. 7 ends. However, if it is determined that Wi-Fi Aware is not stopped, the processing from step S202 is repeated.

As described above, according to this embodiment, in a case where the information processing apparatus 100 operates as the role of the Master during activation of Wi-Fi Aware, the change to the power saving mode can be controlled so as to stably transmit the Beacon.

### Second Embodiment

The second embodiment will be described below for points different from the first embodiment. The first embodiment has been described in which the setting value concerning the power consumption of an information processing apparatus 100 is controlled in accordance with the role in the NAN cluster. The second embodiment will describe an arrangement for referring to a setting value concerning the power consumption of the information processing apparatus 100 and determining the value of the Master Preference. The setting value concerning the power consumption is a setting value indicating whether the first setting is made by operating a “high” button 601 or the second setting is set by operating a “low” button 602.

In this embodiment, specifically, the Master Preference in a state in which the first setting is made by operating the “high” button 601 is different from the Master Preference in a state in the second setting is made by operating the “low” button 602.

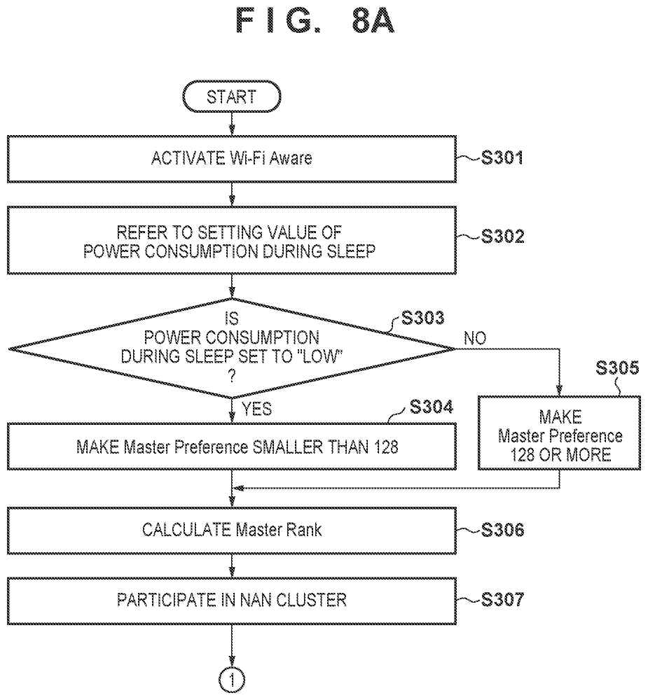

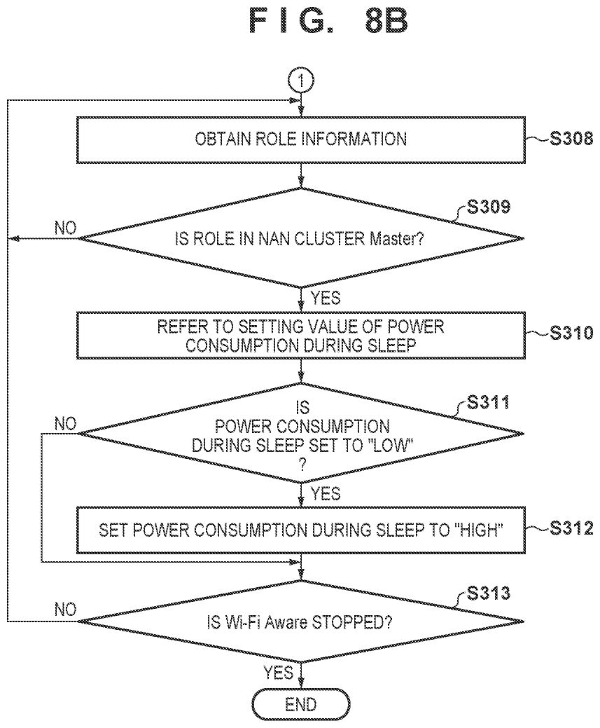

FIGS. 8A and 8B are flowcharts showing processing executed in a case where Wi-Fi Aware is activated in the information processing apparatus 100. The processing in FIGS. 8A and 8B is implemented by a CPU 304 deploying a control program stored in a memory such as a ROM 305 to the RAM 306 and executing it.

After the information processing apparatus 100 is powered on, the CPU 304 activates Wi-Fi Aware in step S301. The activation of Wi-Fi Aware is performed by causing an operation controller 204 to accept an operation from a user.

In step S302, the CPU 304 obtains a setting value concerning a power saving mode. Here, for example, the setting value, for example, “high” or “low” setting value of a setting screen 600 is obtained. The processing in step S302 is executed by the application controller 203.

The CPU 304 determines in step S303 whether the setting value is “low”. If NO in step S303, for example, if “high” is set on the setting screen 600, the process advances to step S305. On the other hand, it is determined that the setting value is “low”, the process advances to step S304. The processing in step S303 is executed by an application controller 203.

In step S304, the CPU 304 sets the Master Preference value to be smaller than 128. That is, if the Master Preference value serving as one of the factors used to determine the role of the NAN device is set to be smaller than 128, the information processing apparatus 100 is hardly set as the Master. On the other hand, in step S305, the CPU 304 sets the Master Preference value to be equal to or larger than 128. That is, if the Master Preference value serving as one of the factors used to determine the role of the NAN device is set to be equal to or larger than 128, the information processing apparatus 100 is easily set as the Master. After steps S304 and S305, the process advances to step S306. The processing operations in steps S304 and S305 are executed by, for example, the application controller 203.

In step S306, the CPU 304 calculates a Master Rank using the Master Preference value determined in step S304 or S305. In this case, as described above, the Master Rank is calculated based on the Master Preference, the random value, and the interface address. The processing in step S306 is executed by, for example, a NAN controller 202.

In step S307, the CPU 304 executes processing for causing a NAN device to participate in the NAN cluster. The processing in step S307 is executed by, for example, the NAN controller 202. Note that at this time, the condition in step S101 of FIG. 5 is not satisfied.

For example, the participation of the NAN device in the NAN cluster is performed as follows. First, the NAN device executes the passive scanning of a neighboring NAN cluster. For example, the NAN device scans 6ch in the passive scanning. If the NAN device receives the Discovery Beacon or Sync Beacon, the NAN device finds a NAN cluster and participates in the found NAN cluster. For the participation of the NAN device to the NAN cluster, the NAN device executes processing determined by the NAN standard in synchronism with the DW of the NAN cluster in accordance with the NAN cluster information received during the passive scanning. First, the NAN device determines the role of three roles, that is, the Master, the Non-Master Sync, and Non-Master Non-Sync in the NAN cluster in accordance with the NAN standard. In the NAN standard, all NAN devices at a timing of generating the NAN cluster and a timing of causing the NAN device to participate in the NAN cluster to operate as the Master. After that, the NAN device can change the role to the Non-Master Sync or Non-Master Non-Sync, as needed, based on the Sync Beacon received within the DW period. The NAN device changes its own role in accordance with, for example, the received signal strength indicator (RSSI) value of the Sync Beacon, the Master Rank in the Sync Beacon, the AMR value, and the Hop Count Field value. In this case, the AMR is the abbreviation of Anchor Master Rank. If the role of the NAN device is not changed over two or more DW periods, it is determined that the role of the NAN device is converged. This role determination processing can end. However, the present invention is not limited to this. For example, this processing may continue for a predetermined period.

Steps S308 to S313 are the same as in the description in steps S202 to S207, and a detailed description thereof will be omitted.

As described above, according to this embodiment, if the setting value concerning the power saving mode is set to “low”, it is possible to reduce a possibility of operating the NAN device as a role of the Master at the time of participating in the NAN cluster. Note that in this embodiment, since the possibility of operating the NAN device as the role of the Master is reduced, the Master Preference value is set. However, another parameter value may be set in place of the Master Preference. Alternatively, another parameter value may be set together with the Master Preference.

In addition, if the setting of the information processing apparatus 100 is changed between the first setting and the second setting after the Master Preference is controlled to a value corresponding to one of the first setting and the second setting in steps S304 and S305, the Master Preference of the information processing apparatus 100 may be changed. More specifically, if the first setting is performed (the second setting is changed to the first setting) by operating the “high” button 601 after step S304 is executed from the second setting of the information processing apparatus 100 to set the Master Preference value to be smaller than 128, step S305 is executed to set the Master Preference value to be equal to or larger than 128.

### Third Embodiment

The third embodiment will be described below for points different from the first and second embodiments. The third embodiment will describe an arrangement for returning the current setting value to the setting value before the change in a case where the setting value concerning the power consumption of an information processing apparatus 100 is changed at the stop time of Wi-Fi Aware.

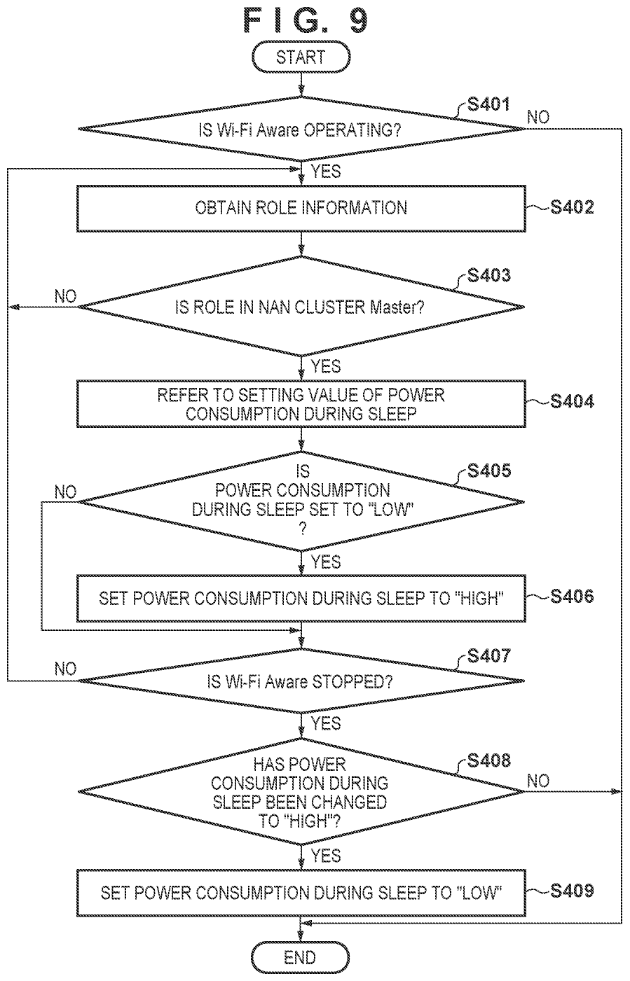

FIG. 9 is a flowchart showing processing of executing when activating Wi-Fi Aware in the information processing apparatus 100. The processing in FIG. 9 is implemented by, for example, the CPU 304 deploying the control program stored in a memory such as the ROM 305 into a RAM 306 and executing it.

Steps S401 to S407 are the same as in the description in steps S201 to S207, and a detailed description thereof will be omitted.

It is determined in step S407 that Wi-Fi Aware is stopped, the process advances to step S408. The CPU 304 determines in step S408 whether processing in step S406 is executed, that is, the setting value is changed to “high”. The processing in step 408 is executed by, for example, an application controller 203. If NO in step S408, the processing in FIG. 9 ends. On the other hand, if it is determined that the processing in step S408 is performed, the CPU 304 changes the setting value to “low” in step S409. After that, the processing in FIG. 9 ends.

As described above, according to this embodiment, if it is determined that Wi-Fi Aware is stopped, and the setting value concerning the power saving mode is changed to “high”, the setting value is changed to “low” before the change. In other words, if it is determined that Wi-Fi Aware is stopped, and a “high” button 601 is operated to set the first setting, the setting value is changed to the second setting. Accordingly, the role in the NAN cluster can be implemented, and at the same time the power saving along with the initial will of the user can be implemented after the stop of Wi-Fi Aware.

Note that in this embodiment, like the first embodiment, the Master Preference value in the first setting may be equal to the Master Preference value in the second setting. In addition, like the second embodiment, the Master Preference value in the first setting may be different from the Master Preference value in the second setting.

### Fourth Embodiment

The fourth embodiment will be described for points different from the first to third embodiments. The fourth embodiment will describe an arrangement for returning the setting value concerning the power saving mode to the setting value before the change based on a fact that the role in the NAN cluster is changed from the Master to a mode other than the Master.

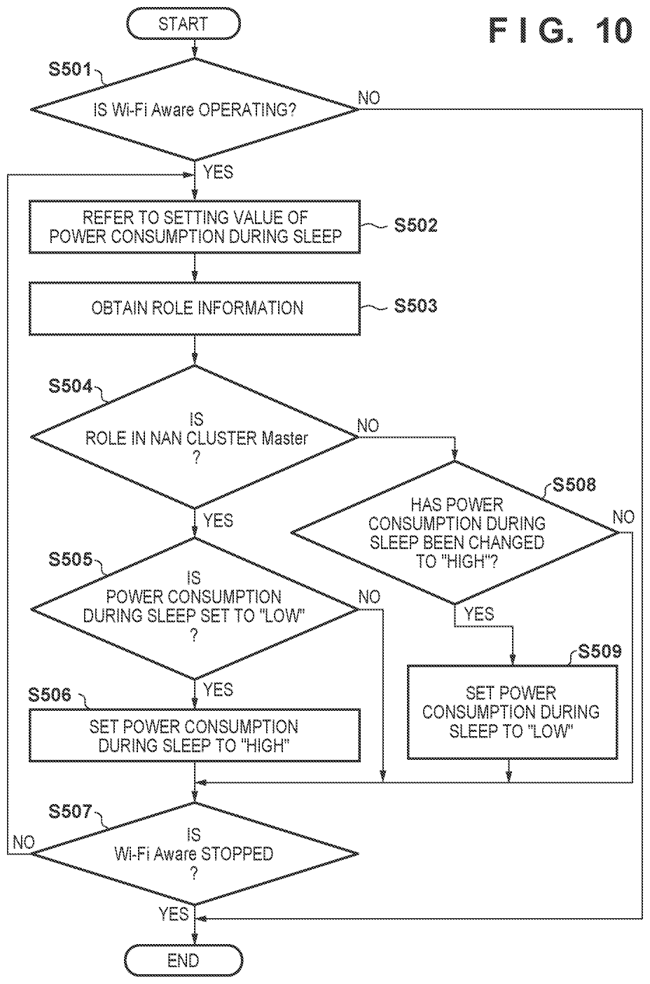

FIG. 10 is a flowchart showing processing executed when activating Wi-Fi Aware in the information processing apparatus 100. The processing in FIG. 10 is implemented by, for example, the CPU 304 deploying the control program stored in a memory such as a ROM 305 into a RAM 306 and executing it.

Step S501 is the same as in the description in step S201 of FIG. 7, and a detailed description will be omitted.

If it is determined in step S501 that Wi-Fi Aware is operating, the CPU 304 obtains the setting value concerning the power saving mode in step S502. Here, for example, the setting value, for example, the “high” or “low” setting value of a setting screen 600 is obtained. The processing in step S502 is executed by, for example, an application controller 203.

Steps S503 to S507 are the same as in the description in steps S202, S203, and S205 to S207 in FIG. 7, and a detailed description thereof will be omitted.

If it is determined in step S504 that the role in the NAN cluster is not the Master, the CPU 304 determines in step S508 whether the processing in step S506 is performed, that is, the setting value is changed to “high”. The processing in step S508 is executed by, for example, the application controller 203. Here, if NO in step S508, the process advances to step S507. On the other hand, if it is determined that the processing in S508 is performed, the CPU 304 sets the setting value to “low” in step S509. That is, the setting value is returned from “high” to “low” before the change. After that, the process advances to step S507.

As described above, according to this embodiment, if the role in the NAN cluster is not the Master, and the setting value concerning the power saving mode is changed to “high”, the setting value is returned to “low” before the change. In other words, if the role of the NAN cluster is not the Master, and a “high” button 601 is operated to set the first setting, the setting value is changed to the second setting. Accordingly, the operation as the Master in the NAN cluster can be implemented, and at the same time the power saving along with the initial will of the user can be implemented if the role is not the Master.

Note that in this embodiment, like the first embodiment, the Master Preference value in the first setting may be equal to the Master Preference value in the second setting. In addition, like the second embodiment, the Master Preference value in the first setting may be controlled to be different from the Master Preference value in the second setting.

In the above description, if the “low” button 602 is operated to set the second setting, after an information processing apparatus 100 is changed to the first power saving mode, the information processing apparatus 100 is changed to the second power saving mode on the basis of the fact that the second condition is satisfied. However, the present invention is not limited to this form. If a “low” button 602 is operated to set the second setting, the information processing apparatus 100 can be changed to the second power saving mode without changing to the first power saving mode based on the fact that the first condition is satisfied in the state in which the information processing apparatus 100 is operated in the normal power mode. If a “high” button 601 is operated to set the first setting, the information processing apparatus 100 may be changed to the first power saving mode based on the fact that the first condition is satisfied in the state in which the information processing apparatus 100 is operated in the normal power mode.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-045789, filed Mar. 22, 2023, which is hereby incorporated by reference herein in their entirety.

What is claimed is:

1. An information processing apparatus capable of executing communication by a Neighbor Awareness Network (NAN), comprising
at least one memory and at least one processor which function as:
a setting unit configured to set, in the information processing apparatus, any setting among a plurality of setting including a first setting and a second setting, wherein the first setting is a setting for operating the information processing apparatus in a predetermined power saving mode based on a fact that a predetermined condition for operating the information processing apparatus in the predetermined power saving mode is satisfied, and the second setting is a setting for inhibiting the information processing apparatus from operating in the predetermined power saving mode even if the predetermined condition is satisfied;
a control unit configured to operate the information processing apparatus in the predetermined power saving mode based on a fact that the predetermined condition is satisfied in a state in which the first setting is validated; and
a change unit configured to execute change processing of changing a state of the information processing apparatus from a state in which the first setting is validated to a state in which the second setting is validated based on a fact that the information processing apparatus is determined to be operated as a Master in a NAN cluster in which the information processing apparatus participates in a state in which the first setting is validated.

2. The apparatus according to claim 1, wherein
in the information processing apparatus, a predetermined value defined by a NAN standard as a factor for determining a role in the NAN cluster, and
the predetermined value set in the information processing apparatus in the state in which the first setting is validated is equal to the predetermined value set in the information processing apparatus in the state in which the second setting is validated.

3. The apparatus according to claim 2, wherein the predetermined value is a Master Preference.

4. The apparatus according to claim 1, wherein predetermined processing for being harder to determine to operate the information processing apparatus as a Master in the NAN cluster in the state in which the second setting is validated than the state in which the first setting is validated is executed.

5. The apparatus according to claim 4, wherein
in the information processing apparatus, a predetermined value defined by a NAN standard as a factor for determining a role in the NAN cluster is set, and
the predetermined processing is processing of controlling the predetermined value set in the information processing apparatus in the state in which the second setting is validated so as to be being harder to determine to operate the information processing apparatus as a Master in the NAN cluster in the state in which the second setting is validated than the state in which the first setting is validated.

6. The apparatus according to claim 5, wherein
the predetermined value is a Master Preference, and
the predetermined processing is processing for setting a Master Preference set in the information processing apparatus in the state in which the second setting is validated to be lower than a Master Preference set in the information processing apparatus in the state in which the first setting is validated.

7. The apparatus according to claim 1, wherein the information processing apparatus operates in one of a plurality of modes including the predetermined energy saving mode, another power saving mode having power consumption higher than that of the predetermined power saving mode, and a normal power mode having power consumption higher than the other power saving mode.

8. The apparatus according to claim 7, further comprising:
a first change unit configured to change a state of the information processing apparatus from a state in which the information processing apparatus is operating in the normal power mode to a state in which the information processing apparatus is operating in the other power saving mode based on a fact that another condition different from the predetermined condition is satisfied in the state in which the information processing apparatus is operating in the normal power mode; and
a second change unit configured to change a state of the information processing apparatus from a state in which the information processing apparatus is operating in the other power saving mode to a state in which the information processing apparatus is operating in the predetermined power saving mode based on satisfaction of the predetermined condition in a state in which the first setting is validated and the information processing apparatus is operating in the other power saving mode, and not to change a state of the information processing apparatus from a state in which the information processing apparatus is operating in the other power saving mode to a state in which the information processing apparatus is operating in the predetermined power saving mode even if the predetermined condition is satisfied in a state the second setting is validated and the information processing apparatus is operating in the other power saving mode.

9. The apparatus according to claim 7, further comprising a change unit configured to change a state of the information processing apparatus from a state in which the information processing apparatus is operating in the normal power mode to a state in which the information processing apparatus is operating in the predetermined power saving mode based on satisfaction of the predetermined condition in a state in which the first setting is validated and the information processing apparatus is operating in the normal power mode, and not to change a state of the information processing apparatus from a state in which the information processing apparatus is operating in the normal power mode to a state in which the information processing apparatus is operating in the predetermined power saving mode even if the predetermined condition is satisfied in a state the second setting is validated and the information processing apparatus is operating in the normal power mode.

10. The apparatus according to claim 7, further comprising a first change unit configured to change a state of the information processing apparatus from a state in which the information processing apparatus is operating in the predetermined power saving mode or the other power saving mode to a state in which the information processing apparatus is operating in the normal power mode based on another condition different from the predetermined condition in a state in which the information processing apparatus is operating in the predetermined power saving mode or a state in which the information processing apparatus is operating in the other power saving mode.

11. The apparatus according to claim 7, wherein
the number of hardware components of the information processing apparatus, which are supplied with power in the normal power mode is larger than the number of hardware components of the information processing apparatus, which are supplied with power in the other power saving mode, and
the number of hardware components of the information processing apparatus, which are supplied with power in the other power saving mode is larger than the number of hardware components of the information processing apparatus, which are supplied with power in the predetermined power saving mode.

12. The apparatus according to claim 1, wherein a state of the information processing apparatus is changed from a state in which the second setting is validated to a state in which the first setting is validated based on a fact that communication by the NAN is stopped in the information processing apparatus in a state in which the second setting is validated by executing the change processing.

13. The apparatus according to claim 1, wherein a state of the information processing apparatus is changed from a state in which the second setting is invalidated to a state in which the first setting is validated based on determination for operating the information processing apparatus as a role other than the Master in the NAN cluster in a state in which the second setting is validated by executing the change processing.

14. The apparatus according to claim 1, wherein the predetermined power saving mode is a mode for executing no communication based on a NAN.

15. The apparatus according to claim 1,
further comprising a display unit configured to display a selection screen for causing a user to select the first setting or the second setting,
wherein the first setting is validated based on selection of the first setting on the selection screen, and
the second setting is validated based on selection of the second setting on the selection screen.

16. The apparatus according to claim 1, wherein the predetermined condition includes a condition that predetermined data is not received for a predetermined period.

17. The apparatus according to claim 1, wherein in a case where the information processing apparatus is determined to operate as a role other than the Master in the NAN cluster in a state in which the first setting is validated, the change processing is not executed.

18. The apparatus according to claim 1, wherein the information processing apparatus is a printer.

19. A control method for an information processing apparatus capable of executing communication by a Neighbor Awareness Network (NAN), comprising:
setting, in the information processing apparatus, any setting among a plurality of setting including a first setting and a second setting, wherein the first setting is a setting for operating the information processing apparatus in a predetermined power saving mode based on a fact that a predetermined condition for operating the information processing apparatus in the predetermined power saving mode is satisfied, and the second setting is a setting for inhibiting the information processing apparatus from operating in the predetermined power saving mode even if the predetermined condition is satisfied;
operating the information processing apparatus in the predetermined power saving mode based on a fact that the predetermined condition is satisfied in a state in which the first setting is validated; and
executing change processing of changing a state of the information processing apparatus from a state in which the first setting is validated to a state in which the second setting is validated based on a fact that the information processing apparatus is determined to be operated as a Master in a NAN cluster in which the information processing apparatus participates in a state in which the first setting is validated.

20. A non-transitory computer-readable storage medium storing a program for operating a computer of an information processing apparatus capable of executing communication by a Neighbor Awareness Network (NAN) to function as:
a setting unit configured to set, in the information processing apparatus, any setting among a plurality of setting including a first setting and a second setting, wherein the first setting is a setting for operating the information processing apparatus in a predetermined power saving mode based on a fact that a predetermined condition for operating the information processing apparatus in the predetermined power saving mode is satisfied, and the second setting is a setting for inhibiting the information processing apparatus from operating in the predetermined power saving mode even if the predetermined condition is satisfied;
a control unit configured to operate the information processing apparatus in the predetermined power saving mode based on a fact that the predetermined condition is satisfied in a state in which the first setting is validated; and
a change unit configured to execute change processing of changing a state of the information processing apparatus from a state in which the first setting is validated to a state in which the second setting is validated based on a fact that the information processing apparatus is determined to be operated as a Master in a NAN cluster in which the information processing apparatus participates in a state in which the first setting is validated.
